(19) United States
(12) Patent Application Publication
(10) Pub. No.: US 2004/0156298 A1
(43) Pub. Date: Aug. 12, 2004

(54) Heat dissipation system

(76) Inventor: Hung-Chu Chu, Taipei (TW)

Correspondence Address: QUINTERO LAW OFFICE, 1617 BROADWAY, 3RD FLOOR, SANTA MONICA, CA, 90404, US

(21) Appl. No.: 10/770,189

(22) Filed: Feb. 2, 2004

(30) Foreign Application Priority Data
Feb. 11, 2003 (TW) 92102768

(51) Int. Cl. G11B 7/00

(52) U.S. Cl. 369/111

(57) ABSTRACT

A heat dissipation system for an optical disk drive having a spindle motor, a circuit board, an IC and a bottom cover. The spindle motor has a rotating shaft with a fixing end. The heat dissipation system includes a fixing plate, a frame, a fan, a guide pipe and a guide channel. The spindle motor is disposed on the fixing plate having a through hole and at least one fixing hole. The fixing end of the rotating shaft passes through the through hole. The frame is disposed on the fixing plate and has at least one fixing portion with a predetermined thickness. The fan has a center connected to the fixing end. The guide pipe is disposed between the frame and circuit board to embrace the fan. The guide channel is closely disposed between the circuit board and bottom cover and extends from the circuit board to the IC.

### BACKGROUND OF THE INVENTION

1. Field of the Invention

The present invention relates to a heat dissipation system, and in particular to a heat dissipation system that enhances the heat dissipation of an optical disc drive.

2. Description of the Related Art

In a conventional optical disc drive, some ICs, such as a main IC and a driving IC, generate tremendous heat when the conventional optical disc drive is operating, thereby increasing temperature rapidly and reducing performance thereof. Even if several holes are formed on the circuit board of the conventional optical disc drive and heat-dissipating silica gel is attached to the ICs, heat dissipation in the conventional optical disc drive is difficult to achieve.

There are several conventional ways to dissipate heat generated by ICs, such as natural cooling, heat sink, heat sink in combination with fan, and fluid cooling. The natural cooling and heat sink methods' employment of temperature differential provides only limited performance. Although the heat sink in combination with fan and fluid cooling methods have better heat-dissipation performance, the manufacturing costs thereof are very high and they occupy a large amount of space in the conventional optical disc drive.

Hence, there is a need to provide an improved heat dissipation system in the limited space of an optical disc drive to enhance heat dissipation of the ICs thereof.

### SUMMARY OF THE INVENTION

Accordingly, an object of the invention is to provide a heat dissipation system for an optical disc drive having a spindle motor, a circuit board, an IC and a bottom cover. The spindle motor has a rotating shaft with a fixing end. The heat dissipation system comprises a fixing plate, a frame, a fan, a guide pipe and a guide channel. The fixing plate is disposed in the optical disc drive and rotates slightly around the connection portion between the optical disc drive and the fixing is plate. The spindle motor is disposed on the fixing plate. The fixing plate defines a through hole and at least one fixing hole. The fixing end of the rotating shaft passes through the through hole. The frame is disposed on the fixing plate and has at least one fixing portion with a predetermined thickness. The fixing portion is fixed to the fixing hole of the fixing plate. The fan has a center connected to the fixing end of the rotating shaft. The guide pipe is disposed between the frame and the circuit board to embrace the fan. The circuit board has a guide opening connected to the guide pipe. The guide channel is closely disposed between the circuit board and the bottom cover and extends from the guide opening of the circuit board to the IC.

Preferably, the fan presents a relatively thin profile.

Preferably, the guide pipe is made of a flexible material.

Preferably, the guide pipe is disposed in the guide opening of the circuit board.

Preferably, the inner wall of the guide channel is made of a heat-dissipating material.

Preferably, the outer wall of the guide channel is made of a thermal isolation material.

Preferably, the guide channel further comprises a contracted portion corresponding to the IC to increase the speed of air flowing through the IC.

Preferably, the heat dissipation system further comprises a fin assembly disposed on the IC to enhance heat dissipation thereof.

Preferably, the bottom cover further comprises an inlet through which air enters the optical disc drive to be blown by the fan.

Preferably, the heat dissipation system further comprises a curved barricade disposed in the closed end of the guide channel.

Preferably, the closed end of the guide channel is curved and sloped.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the inside structure of an optical disc drive using the heat dissipation system of the invention;

FIG. 2 is an exploded perspective view showing the heat dissipation system of the first embodiment of the invention;

FIG. 3 is a schematic partial cross section showing the optical disc drive using the heat dissipation system of the first embodiment of the invention;

FIG. 4 is a schematic partial cross section showing the optical disc drive using the heat dissipation system of the invention;

FIG. 5 is an exploded perspective view showing the heat dissipation system of the second embodiment of the invention; and

FIG. 6 is a schematic partial cross section showing the optical disc drive using the heat dissipation system of the second embodiment of the invention.

### DETAILED DESCRIPTION OF THE INVENTION

Embodiments

### First Embodiment

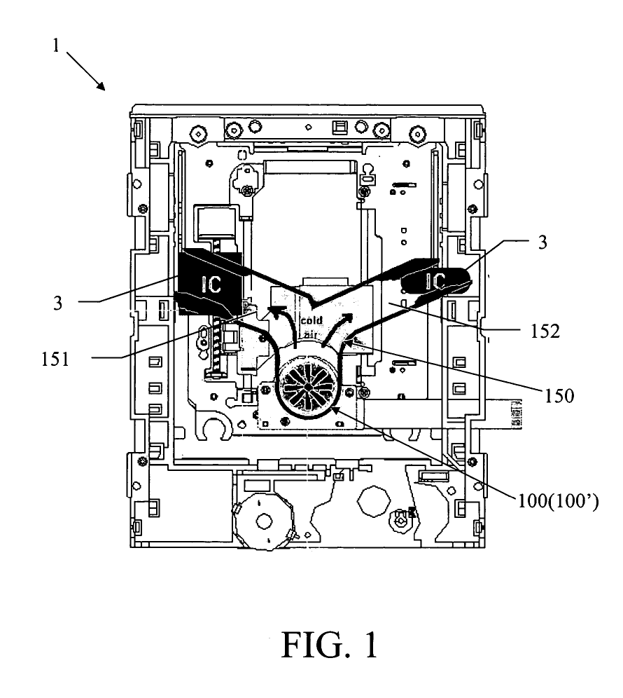

Referring to FIG. 1, an optical disc drive 1 has a spindle motor 4 (not shown in FIG. 1), a circuit board 2 (not shown in FIG. 1), two ICs 3 (such as a main IC and a driving IC) and a bottom cover 5 (not shown in FIG. 1).

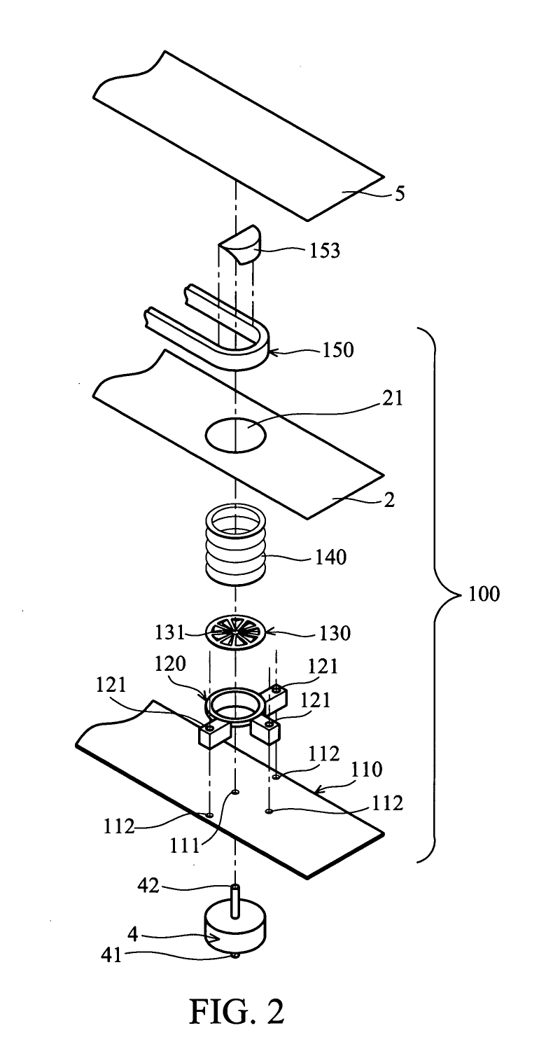

Referring to FIG. 2, the heat dissipation system 100 comprises a fixing plate 110, a frame 120, a fan 130, a guide pipe 140 and a guide channel 150. Meanwhile, the spindle motor 4 has a rotating shaft 41 with a fixing end 42.

The fixing plate 110 has a through hole 111 and three fixing holes 112. The fixing end 42 of the spindle motor 4 is disposed in the through hole 111.

The frame 120 is disposed on the fixing plate 110 and has three fixing portions 121 corresponding to the three fixing holes 112 of the fixing plate 110. The three fixing portions 121 have a predetermined thickness. The fixing portions 121 can be fixed to the fixing holes 112 of the fixing plate 110 by bolts (not shown), respectively. When the fixing portions 121 are fixed to the fixing holes 112, a gap exists between the frame 120 and the fixing plate 110 because of the predetermined thickness of the fixing portions 121.

The fan 130 has a center 131. The fixing end 42 of the rotating shaft 41 is connected to the center 131 of the fan 130 by passing through the through hole 111 of the fixing plate 110. Thus, the fan 130 rotates with the rotating shaft 41 of the spindle motor 4.

The guide pipe 140 is disposed between the frame 120 and circuit board 2 to embrace the fan 130. Additionally, the circuit board 2 has a guide opening 21. The guide pipe 140 is connected to the circuit board 2 by surrounding the guide opening 21.

The guide channel 150 is disposed between the circuit board 2 and bottom cover 5 and extends from the guide opening 21 of the circuit board 2 to the ICs 3. Specifically, the guide channel 150 is closely laid between the circuit board 2 and bottom cover 5.

In addition, a curved barricade 153 is disposed between the guide channel 150 and bottom cover 5. Specifically, the curved barricade 153 is disposed on the edge of the close end of the guide channel 150, thereby streamlining air flow through the guide channel 150.

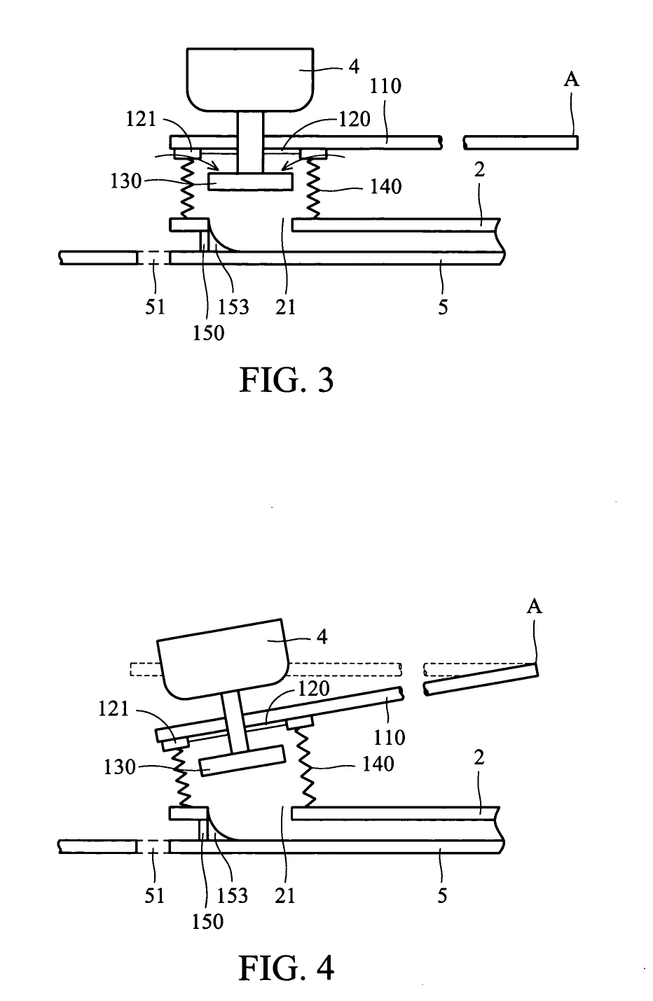

Referring to FIG. 3, the fixing plate 110 is disposed in the optical disc drive 1 and rotates slightly around the connection portion A between the optical disc drive 1 and fixing plate 110. Additionally, the optical disc drive 1 further includes a tray (not shown) to load an optical disc. When the tray exits, the fixing plate 110 rotates downward around the connection portion A such that the spindle motor 4 does not interfere with the tray, as shown in FIG. 4. The guide pipe 140 is made of a flexible material and can withstand compression and bending resulting from the downward movement of the fixing plate 110.

Additionally, in order to not increase the load on the spindle motor 4, the fan 130 is lightweight and relatively thin. In this embodiment, the guide pipe 140 is disposed in the guide opening 21 of the circuit board 2.

In addition, the inner wall of the guide channel 150 is made of a heat-dissipating material to help transfer heat generated by the optical disc drive 1 to the bottom cover 5. The outer wall of the guide channel 150 is made of a thermal isolation material to prevent heat from spreading into the optical disc drive 1.

Furthermore, the curved barricade 153 can be omitted, and the closed end of the guide channel 150 can be curved and sloped to streamline the airflow therein.

The following description explains operation of the heat dissipation system 100 of this embodiment.

As shown in FIG. 1 and FIG. 3, when the spindle motor 4 rotates (the ICs 3 are generating enormous heat), the fan 130 rotates with the spindle motor 4. Cold air enters the optical disc drive 1 via an inlet 51 of the bottom cover 5 to be blown by the fan 130. At this time, the cold air flows into the guide pipe 140 via the gap between the fixing plate 110 and the frame 120. Then, the cold air blown by the fan 130 is transmitted to the guide channel 150 disposed between the circuit board 2 and bottom cover 5 through the guide pipe 140 and guide opening 21. Further, as shown in FIG. 1, the cold air is transmitted to the two ICs 3 through two branch channels 151 and 152 of the guide channel 150, respectively. Thus, the ICs 3 are cooled down and the heat generated thereby is dissipated. Specifically, the wall of each branch channel 151 or 152 on each IC 3 is thicker, so that the width thereof on each IC 3 is reduced. The speed of the cold air flowing through each IC 3 is increased, such that the heat generated thereby is dissipated more rapidly by the cold air. Then, hot air flowing through each IC 3 is transmitted out of the optical disc drive 1 through a plurality of outlets (not shown) formed on the bottom cover 5 or the sidewall of the optical disc drive 1.

In addition, in order to further enhance the heat dissipation of each IC 3, a fin assembly (not shown) can be selectively disposed thereon.

Specifically, the heat dissipation system 100 of this embodiment is not limited to cooling only two ICs. The guide channel 150 can have more branch channels to cool more ICs or heat sources.

### Second Embodiments

Elements corresponding to those in the first embodiment are given the same reference numerals, and explanation thereof will be omitted for simplification of the description.

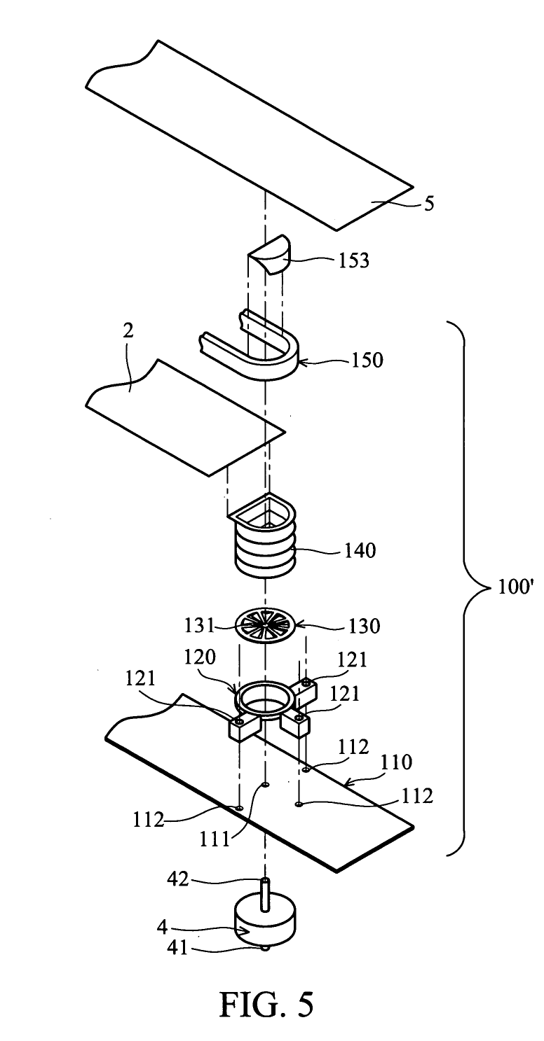

Referring to FIG. 5, the difference between this embodiment and the first embodiment is that the guide pipe 140 of the heat dissipation system 100′ is connected to the guide channel 150, rather than the circuit board 2. Meanwhile, the guide channel 150 is closely laid between the circuit board 2 and the bottom cover 5.

The operation of the heat dissipation system 100′ of this embodiment is similar to that of the first embodiment.

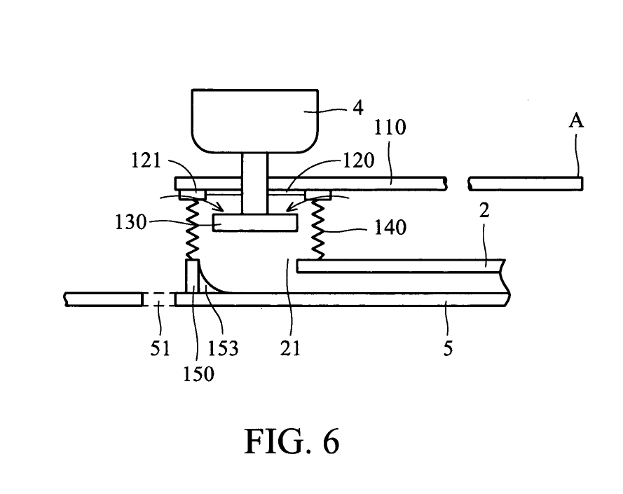

As shown in FIG. 1 and FIG. 6, when the spindle motor 4 rotates (the ICs 3 are generating enormous heat), the fan 130 rotates with the spindle motor 4. Cold air enters the optical disc drive 1 via an inlet 51 of the bottom cover 5 to be blown by the fan 130. At this time, the cold air flows into the fan 130 via the gap between the fixing plate 110 and the frame 120. Then, the cold air blown by the fan 130 is directly transmitted to the guide channel 150 disposed between the circuit board 2 and bottom cover 5 through the guide pipe 140. Further, as shown in FIG. 1, the cold air is transmitted to the two ICs 3 through two branch channels 151 and 152 of the guide channel 150, respectively. Thus, the ICs 3 are cooled down and the heat generated thereby is dissipated. Specifically, the wall of each branch channel 151 or 152 on each IC 3 is thicker, so that the width thereof on each IC 3 is reduced. The speed of the cold air flowing through each IC 3 is increased, such that the heat generated thereby is dissipated more rapidly by the cold air. Then, hot air flowing through each IC 3 is transmitted out of the optical disc drive 1 through a plurality of outlets (not shown) formed on the bottom cover 5 or the sidewall of the optical disc drive 1.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A heat dissipation system for an optical disc drive having a spindle motor, a circuit board, an IC and a bottom cover, the spindle motor having a rotating shaft with a fixing end, the heat dissipation system comprising:
a fixing plate disposed in the optical disc drive and rotating slightly around a connection portion between the optical disc drive and the fixing plate, the spindle motor disposed on the fixing plate, the fixing plate having a through hole and at least one fixing hole, and the fixing end of the rotating shaft passing through the through hole;
a frame disposed on the fixing plate and having at least one fixing portion with a predetermined thickness, wherein the fixing portion is fixed to the fixing hole of the fixing plate;
a fan having a center connected to the fixing end of the rotating shaft;
a guide pipe disposed between the frame and the circuit board to embrace the fan, wherein the circuit board has a guide opening connected to the guide pipe; and
a guide channel closely disposed between the circuit board and the bottom cover and extending from the guide opening of the circuit board to the IC.

2. The heat dissipation system as claimed in claim 1, wherein the fan presents a relatively thin profile.

3. The heat dissipation system as claimed in claim 1, wherein the guide pipe is made of a flexible material.

4. The heat dissipation system as claimed in claim 1, wherein the guide pipe is disposed in the guide opening of the circuit board.

5. The heat dissipation system as claimed in claim 1, wherein the inner wall of the guide channel is made of a heat-dissipating material.

6. The heat dissipation system as claimed in claim 1, wherein the outer wall of the guide channel is made of a thermal isolation material.

7. The heat dissipation system as claimed in claim 1, wherein the guide channel further comprises a contracted portion corresponding to the IC to increase the speed of air flowing through the IC.

8. The heat dissipation system as claimed in claim 1, further comprising a fin assembly disposed on the IC to enhance heat dissipation thereof.

9. The heat dissipation system as claimed in claim 1, wherein the bottom cover further comprises an inlet through which air enters the optical disc drive to be blown by the fan.

10. The heat dissipation system as claimed in claim 1, further comprising a curved barricade disposed in the closed end of the guide channel.

11. The heat dissipation system as claimed in claim 1, wherein the closed end of the guide channel is curved and sloped.

12. A heat dissipation system for an optical disc drive having a spindle motor, a circuit board, an IC and a bottom cover, the spindle motor having a rotating shaft with a fixing end, the heat dissipation system comprising:
a fixing plate disposed in the optical disc drive and rotating slightly around a connection portion between the optical disc drive and the fixing plate, the spindle motor disposed on the fixing plate, the fixing plate having a through hole and at least one fixing hole, and the fixing end of the rotating shaft passing through the through hole;
a frame disposed on the fixing plate and having at least one fixing portion with a predetermined thickness, wherein the fixing portion is fixed to the fixing hole of the fixing plate;
a fan having a center connected to the fixing end of the rotating shaft;
a guide pipe disposed between the frame and the bottom cover to embrace the fan; and
a guide channel connected to the guide pipe and closely disposed between the circuit board and the bottom cover, wherein the guide channel extends from the guide pipe to the IC.

13. The heat dissipation system as claimed in claim 12, wherein the fan presents a relatively thin profile.

14. The heat dissipation system as claimed in claim 12, wherein the guide pipe is made of a flexible material.

15. The heat dissipation system as claimed in claim 12, wherein the inner wall of the guide channel is made of a heat-dissipating material.

16. The heat dissipation system as claimed in claim 12, wherein the outer wall of the guide channel is made of a thermal isolation material.

17. The heat dissipation system as claimed in claim 12, wherein the guide channel further comprises a contracted portion corresponding to the IC to increase the speed of air flowing through the IC.

18. The heat dissipation system as claimed in claim 12, further comprising a fin assembly disposed on the IC to enhance heat dissipation thereof.

19. The heat dissipation system as claimed in claim 12, wherein the bottom cover further comprises an inlet through which air enters the optical disc drive to be blown by the fan.

20. The heat dissipation system as claimed in claim 12, further comprising a curved barricade disposed in the closed end of the guide channel, wherein the closed end of the guide channel is curved and sloped.
